(19) United States
(12) Patent Application Publication
(10) Pub. No.: US 2025/0047390 A1
(43) Pub. Date: Feb. 6, 2025

(54) OPTICAL TRANSMITTER, OPTICAL TRANSCEIVER USING OPTICAL TRANSMITTER, AND WAVELENGTH CONTROL METHOD

(71) Applicant: FUJITSU LIMITED, Kawasaki-shi (JP)

(72) Inventors: Jun MATSUI, Kawasaki (JP); Shinsuke TANAKA, Hiratsuka (JP); Tomoyuki AKIYAMA, Yokohama (JP)

(73) Assignee: FUJITSU LIMITED, Kawasaki-shi (JP)

(21) Appl. No.: 18/751,975

(22) Filed: Jun. 24, 2024

(30) Foreign Application Priority Data
Jul. 31, 2023 (JP) 2023-124119

(51) Int. Cl. H04B 10/572; H04J 14/02

(52) U.S. Cl. CPC H04B 10/572; H04J 14/0224

(57) ABSTRACT

An optical transmitter includes a frequency comb light source; a demultiplexer configured to demultiplex light output from the frequency comb light source into n channels (n is an integer of 2 or greater) at a wavelength interval Δλ; and n filters respectively connected to n output ports of the demultiplexer, the n filters being configured to reduce a high-order spectral component for each wavelength.

### CROSS-REFERENCE TO RELATED APPLICATIONS

This application is based upon and claims the benefit of priority of the prior Japanese Patent Application No. 2023-124119, filed on Jul. 31, 2023, the entire contents of which are incorporated herein by reference.

### FIELD

The present disclosure relates to an optical transmitter, an optical transceiver using the optical transmitter, and a wavelength control method.

### BACKGROUND

In order to support large data communication, optical communication of a wavelength division multiplexing (WDM) system is performed. In particular, in the dense WDM, a large number of channels are densely arranged at a narrow wavelength interval. In the WDM, a multi-wavelength light source that outputs light corresponding to a wavelength of each channel is required. As the multi-wavelength light source, a light source using an optical frequency comb is promising (for example, see Patent Document 1). The optical frequency comb has a comb-like spectral shape in which a large number of longitudinal modes are distributed at a predetermined repetition frequency on the frequency axis. Each of the comb modes appearing at equal intervals is a continuous oscillation laser (amplified radiation of light by stimulated emission), and is suitable for WDM optical transmission.

As a multiplexer for multiplexing a large number of channels, a cascaded AMZ triplet (CAT) configuration in which multiple asymmetric Mach-Zehnder (AMZ) interferometers are connected in multiple stages is proposed (for example, see Patent Document 2).

### RELATED ART DOCUMENT

### Patent Document

[Patent Document 1]U.S. Patent Application Publication No. 2018-0083599 [Patent Document 2]Japanese Laid-open Patent Application Publication No. 2021-152569

### SUMMARY

In one aspect of the embodiments of the present disclosure, an optical transmitter includes a frequency comb light source; a demultiplexer configured to demultiplex light output from the frequency comb light source into n channels (n is an integer of 2 or greater) at a wavelength interval Δλ; and n filters respectively connected to n output ports of the demultiplexer, the n filters being configured to reduce a high-order spectral component for each wavelength.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a general configuration of an optical transmitter using an optical frequency comb light source;

FIG. 2 is a diagram illustrating a technical problem that occurs when the optical frequency comb light source is used;

FIG. 3 is a schematic diagram of an optical transmitter according to an embodiment;

FIG. 4 is a schematic diagram of a modified example of the optical transmitter of FIG. 3;

FIG. 5 is a diagram illustrating an example of a demultiplexer;

FIG. 6 is a schematic diagram of a filter connected to output ports of the demultiplexer of FIG. 5;

FIG. 7 is a diagram illustrating filter characteristics of the embodiment;

FIG. 8 is a flowchart of wavelength control of the optical transmitter;

FIG. 9 is a schematic diagram illustrating a modified example of the filter;

FIG. 10 is a diagram illustrating a characteristic of the filter of FIG. 9;

FIG. 11 is a diagram illustrating an effect of the configuration of the embodiment; and

FIG. 12 is a schematic diagram of an optical transceiver using the optical transmitter of the embodiment.

### DESCRIPTION OF EMBODIMENTS

In a light source using an optical frequency comb (hereinafter referred to as a “frequency comb light source”), a higher-order spectrum is generated in addition to a fundamental mode. When light generated by the optical frequency comb is demultiplexed by a demultiplexer, a spectrum of a higher-order mode transmits through due to the periodicity of a filter, and crosstalk occurs with respect to a signal wavelength for transmission. In the OIF 400ZR standard, to which digital coherent optical communication modules conform, the crosstalk of the interferometer is defined to be −35 dB or less. As the optical frequency comb light source has higher performance, the power of the higher-order spectrum increases, and there is a possibility that the specification of the standard cannot be satisfied. In a configuration in which only a wavelength band for transmission is extracted from an output of the optical frequency comb by a fixed filter, wavelength fluctuations of the optical frequency comb cannot be followed.

According to at least one embodiment of the present disclosure, in an optical transmitter using an optical frequency comb light source, crosstalk arising from a high-order spectrum can be suppressed.

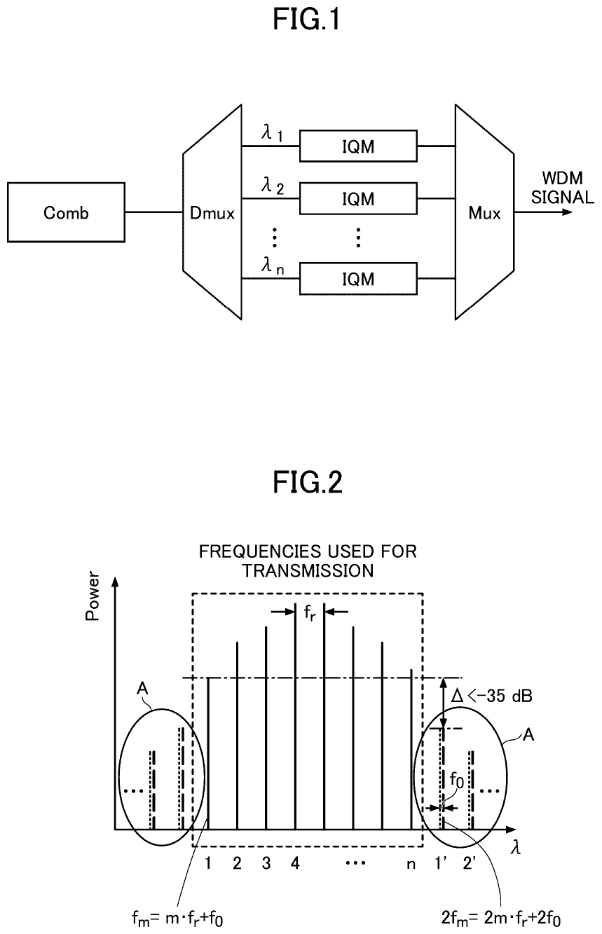

Before describing an optical transmitter and a wavelength control according to an embodiment, a new technical problem that occurs when a frequency comb light source is used for optical communication will be described in detail with reference to FIG. 1 and FIG. 2. FIG. 1 illustrates a general configuration of an optical transmitter using a frequency comb light source (represented by “Comb” in the drawing). Light output from the frequency comb light source is demultiplexed into multiple channels, that is, wavelengths λ1 to λn by a demultiplexer (represented by “Dmux” in the drawing). The light of each wavelength is incident on a corresponding IQ modulator (represented by “IQM” in the drawing) and modulated by a data signal input to the IQ modulator. The modulated optical signals on n channels are multiplexed by a multiplexer (represented by “Mux” in the drawing), and a WDM signal is output.

FIG. 2 illustrates a comb spectrum generated by the frequency comb light source. When an ultrashort pulse train output from the frequency comb light source is Fourier-transformed on the frequency axis, the comb spectrum of FIG. 2 is obtained. Multiple comb lines are arranged at equal intervals at a repetition frequency fᵣ. Each of the comb lines can be used as a continuous wave laser beam.

In the optical frequency comb, a high-order spectrum A is generated. For example, each of the comb lines included in the frequency band used for transmission is allocated to n channels. The comb lines assigned to the n channels are represented by solid lines. The m-th comb line of the optical frequency comb, i.e., the m-th comb mode, to the (m+n)-th comb line are assigned to n channels. The dotted lines equally spaced on both sides of the transmission frequency band are comb lines outside the transmission frequency band. When the comb lines are virtually extended to zero frequency at the repetition rate fᵣ, a frequency difference f₀ is caused between the zero frequency and a first comb line (comb mode). The difference f₀ is called a carrier-envelope offset, which corresponds to a phase difference between a carrier wave and an envelope included in the ultrashort pulse on the time axis. The frequency fₘ of the first channel to which the m-th comb line is assigned is represented by m·fᵣ+f₀.

When the (n+m+1)-th comb line is a virtual channel 1′, a high-order spectrum due to a second harmonic of the channel number 1 appears in the vicinity of the virtual channel 1′. The frequency of the higher-order spectrum is a frequency 2fₘ, which is twice the frequency of the channel number 1, and is represented by 2m·fᵣ+2f₀. If a power difference A between the comb line of the channel number 1 and the higher-order spectrum in the vicinity of the virtual channel 1′ is −35 dB or less, the crosstalk requirement required by the standard is satisfied. However, the power difference between the comb line of the channel number 1 and the higher-order spectrum in the vicinity of the virtual channel 1′ is generally about −10 dB, and the probability of signal deterioration due to the crosstalk is high. The periodicity of the filter in the demultiplexer allows not only the second harmonic, but also the third harmonic and higher-order spectral components to transmit.

In the embodiment, the high-order spectral components are reduced to suppress signal deterioration due to the crosstalk. In the following, specific configurations and methods of an optical transmitter and wavelength control according to the embodiment will be described with reference to the drawings. The following embodiment is an example for embodying the technical idea of the present disclosure, and does not limit the disclosure. The size, positional relationship, and the like of the constituent elements illustrated in the drawings may be exaggerated for easy understanding of the invention. The same constituent elements or functions are denoted by the same names or reference symbols, and redundant description may be omitted.

### <Configuration of Optical Transmitter>

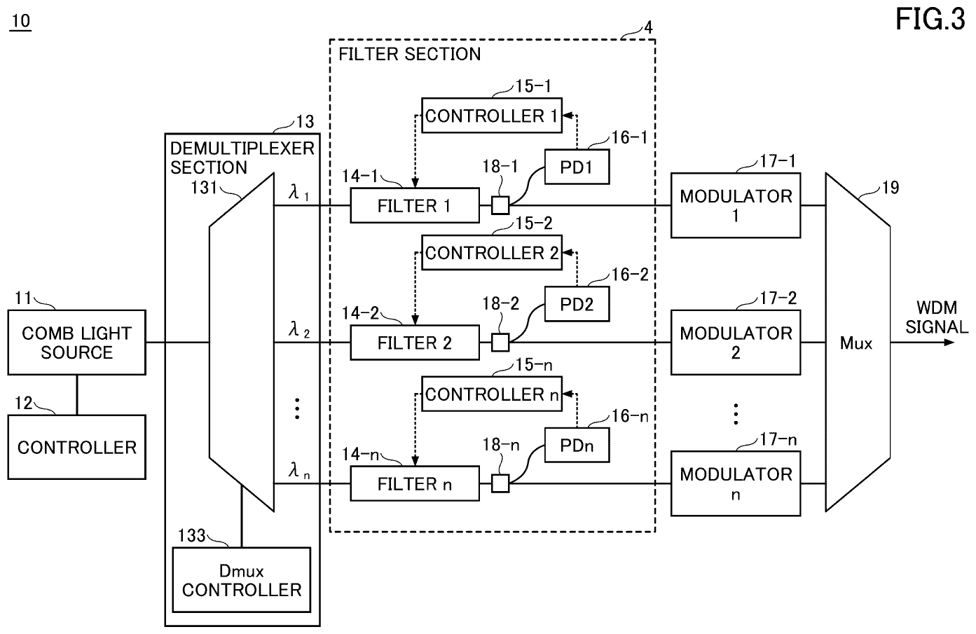

FIG. 3 is a schematic diagram of an optical transmitter 10 according to the embodiment. The optical transmitter 10 includes a frequency comb light source 11, a demultiplexer section 13, a filter section 4, modulators 17-1 to 17-n, and a multiplexer 19. The demultiplexer section 13 includes a demultiplexer 131 configured to demultiplex the light output from the frequency comb light source 11 into n channels (n is an integer of 2 or more) at a predetermined wavelength interval Δλ. The demultiplexer 131 may have any configuration as long as the demultiplexer can separate light at a desired wavelength interval, but a waveguide type demultiplexer formed by a silicon photonics technology is suitable for integration. As the waveguide type demultiplexer, the above-described demultiplexer having the CAT configuration, an arrayed waveguide grating (AWG), or the like may be used.

The filter section 4 includes n filters 14-1 to 14-n connected to n output ports of the demultiplexer 131. Each of the filters 14-1 to 14-n reduces a high-order spectral component for each wavelength and suppresses the crosstalk with respect to the fundamental wave. The light transmitting through the filters 14-1 to 14-n is incident on the corresponding modulators 17-1 to 17-n. The light beams of the respective channels that are modulated by the modulators 17-1 to 17-n are multiplexed by the multiplexer 19 and output as the WDM signal.

The optical transmitter 10 includes a controller 12 configured to control the frequency comb light source 11, a demultiplex controller 133 configured to control the demultiplexer 131, and controllers 15-1 to 15-n configured to control the filters 14-1 to 14-n. The controller 12, the demultiplex controller 133, and the controllers 15-1 to 15-n may be implemented by one processor or may be implemented by individual microprocessors or logic devices.

The frequency comb light source 11 has a configuration suitable to generate an optical frequency comb in a desired wavelength band used in optical communication. For example, a mode-locked laser using an Er-doped fiber that generates a frequency-comb in a 1550 nm band may be used. The mode-locked laser has a fixed phase relationship between longitudinal modes in a resonator (a mode-locked state), and generates and outputs an ultrashort pulse at a peak position where the phases of the wavelengths are aligned. The optical frequency comb is obtained by Fourier-transforming the ultrashort pulse train on the time axis onto the frequency axis. The controller 12 controls the repetition rate fᵣ, the carrier-envelope offset f₀, the power, the resonator temperature, and the like of the optical frequency comb.

The demultiplex controller 133 controls a phase of light propagating through the waveguide of the demultiplexer 131 to adjust the effective optical path length, and separates the output light from the frequency comb light source 11 into n light beams at a wavelength interval Δλ. The phase of the light propagating through the waveguide can be controlled by adjusting the level of an electric field applied to the waveguide or the temperature of a heater provided in the waveguide to change the refractive index of the waveguide.

The filter section 4 includes photodetectors (PD) 16-1 to 16-n and controllers 15-1 to 15-n provided corresponding to the filters 14-1 to 14-n, respectively. The solid line of the filter section 4 indicates an optical waveguide, and the dotted line indicates an electric signal line. Couplers 18-1 to 18-n on the outputs of the filters 14-1 to 14-n (hereinafter, may be collectively referred to as “filters 14”) branch portions of the light transmitting through the filters 14, and the branched light is detected by the PD 16-1 to PD 16-n. The detection results of the PD 16-1 to PD 16-n are input to the controllers 15-1 to 15-n.

The controllers 15-1 to 15-n (hereinafter, may be collectively referred to as “controllers 15”) perform feedback control on the transmission characteristics of the filters 14-1 to 14-n based on the detection results of the PD 16-1 to PD 16-n (hereinafter, may be collectively referred to as “PDs 16”) to reduce high-order spectral components. The controller 15 changes the center wavelength of the transmission spectrum of the filter 14 based on the detection result of the corresponding PD 16, that is, the power of the transmitted light of the corresponding filter 14, and reduces the high-order spectral components while following fluctuations in the wavelength of the frequency comb light source. Unlike a general LD array, the frequency comb light source 11 shifts the entire comb line while maintaining the wavelength intervals even when the wavelength fluctuates. Therefore, by the filter section 4 following the wavelength fluctuations of the frequency comb light source 11, and causing the fundamental wave to transmit through while suppressing the high-order spectral components, high-precision demultiplexing can be achieved. A specific configuration example and a control example of the filters 14-1 to 14-n will be described later.

The comb light beams of the respective wavelengths from which the high-order spectral components have been removed by the filters 14-1 to 14-n are incident on the corresponding modulators 17-1 to 17-n. The light beams of the respective channels modulated by the modulators 17-1 to 17-n are multiplexed by the multiplexer 19 and output as the WDM signal.

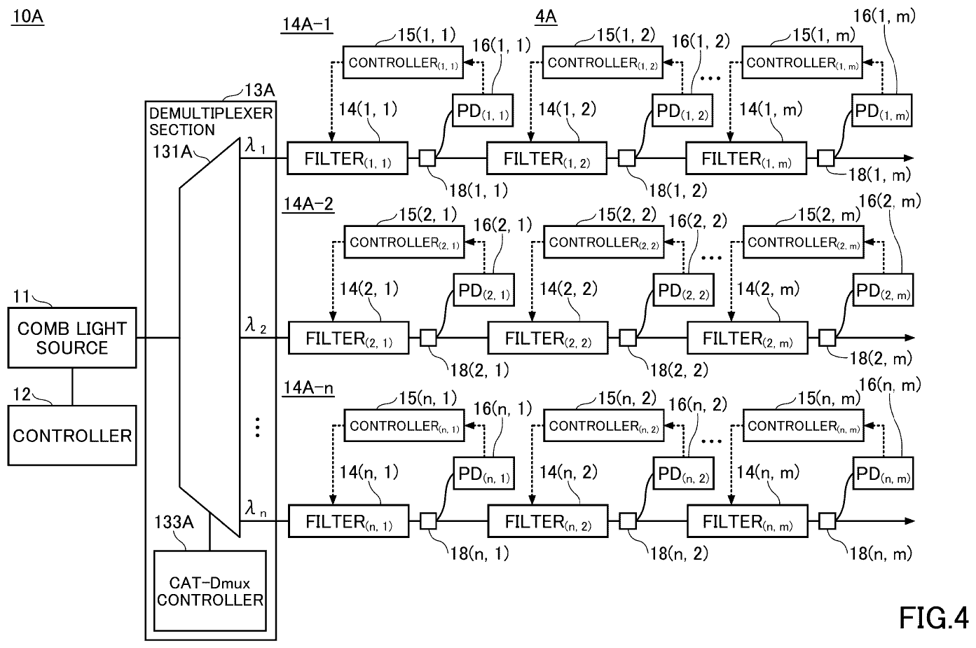

FIG. 4 is a schematic diagram of an optical transmitter 10A, which is a modified example of FIG. 3. The optical transmitter 10A includes a demultiplexer section 13A and a filter section 4A. The demultiplexer section 13A includes a demultiplexer 131A having the CAT configuration and a demultiplex controller 133A configured to control the demultiplexer 131A. The demultiplex controller 133A is represented as “CAT-Dmux controller” in the drawing. The filter section 4A includes filters 14A-1 to 14A-n (hereinafter, may be collectively referred to as “filters 14A”) connected to the respective outputs of the demultiplexer 131A.

Each of the filters 14A includes m filters 14(i, k) connected in series. Here, i is a number of a filter array among filter arrays connected to n outputs of the demultiplexer section 13A, and is an integer from 1 to n. Additionally, k is a number of the filter connected in series with other filters in each filter array, and is an integer from 1 to m. The k-th filter of the filter array connected to the i-th output port is represented by 14(i, k). The transmission spectra of the m filters 14(i, k) have individual periods. By connecting filters of different transmission spectra in series, a higher-order spectral component is removed. The number m of the filters connected in series may be determined based on how the higher-order spectrum stands.

In the first channel corresponding to a wavelength λ1, filters 14(1, 1), 14(1, 2), . . . , 14(1, m) are connected in series, and controllers 15(1, 1), 15(1, 2), . . . , 15(1, m) are provided for the respective filters. The light transmitted through each filter 14(1, k) is branched by the coupler 18(1, k) and monitored by the PD(1, k), and the monitoring result is input to the corresponding controller 15(1, k). The controller 15(1, k) performs feedback control on the filter 14(1, k) based on the power of the monitored transmitted light. That is, the peak of the transmission spectrum is controlled to match with or approach the wavelength of the output port of the channel number 1 of the demultiplexer section 13A. Here, substantially the same filtering process is performed on the second to n-th channels.

### <Configuration Example of Demultiplexer >

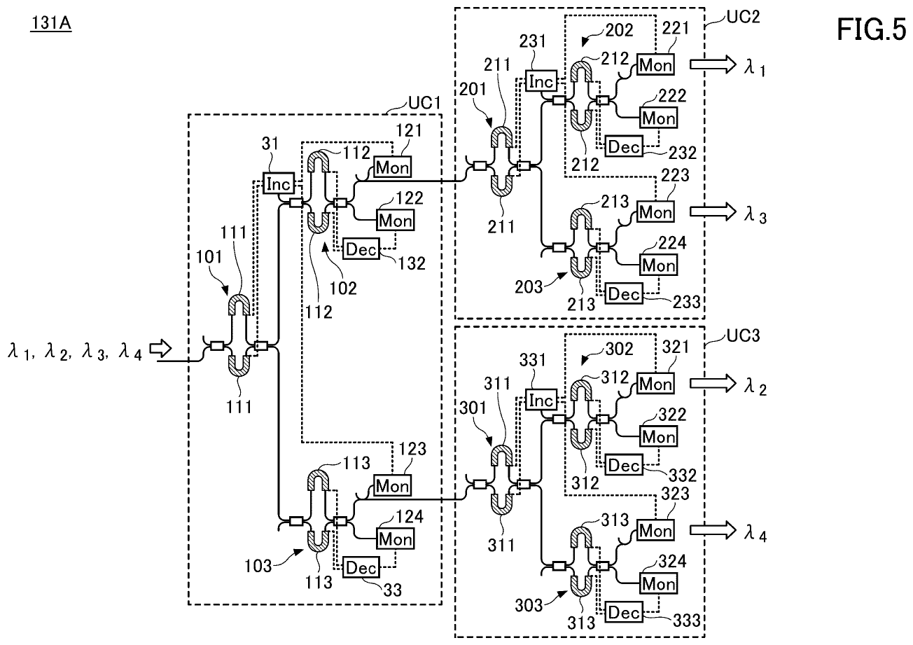

FIG. 5 illustrates a configuration example of the demultiplexer 131A having the CAT configuration. Here, for the sake of simplicity, the four wavelengths λ1, λ2, λ3, and λ4 are demultiplexed. The demultiplexer 131A includes 2^{L}−1 unit circuits UC that are connected in a tree-shaped branching structure in L stages (L is an integer of 1 or greater). When four wavelengths are demultiplexed, 2²−1, that is, three unit circuits UC1, UC2, and UC3 connected in two stages are connected in a tree-shaped branching structure. Each of the unit circuits UC has one input port and two output ports, and the unit circuits UC at the next stages are connected in series to the output ports, respectively.

In each of the unit circuits UC, three asymmetric Mach-Zehnder interferometers (AMZ) having the identical arm length differences are connected in a cascade. Here, the arm length difference is an effective arm length difference in which the refractive index of the waveguide is taken into consideration. Hereinafter, the term “arm length difference” refers to the effective arm length difference. The “identical” arm length differences indicate that the designed arm length differences are identical, and includes manufacturing variations, allowable errors, and the like. Each of the AMZs has one input port and two output ports, and the second and third AMZs are connected to the two output ports of the first AMZ.

The unit circuit UC1 includes AMZs 101, 102, and 103 connected in a cascade, and phase shifters 111, 112, and 113 are provided in each of the AMZs. The arm length differences of the AMZs 101, 102, and 103 is set so that the incident light is separated for wavelengths of adjacent channel intervals. With this, λ1 and λ3 are output to one output port, and λ2 and λ4 are output to the other output port. A monitor 121 is connected to one output port of the second AMZ 102, and a monitor 122 is connected to the other port. The unit circuit UC2 at the next stage is connected to the output port to which the monitor 121 is connected. Similarly, a monitor 123 is connected to one output port of the third AMZ 103, and a monitor 124 is connected to the other port. The unit circuit UC3 at the next stage is connected to the output port to which the monitor 123 is connected.

The monitoring results of the monitors 121 and 123 are input to the controller 31. The controller 31 controls the phase shifter 111 of the AMZ 101 to control the transmission characteristic of the AMZ 101 in a direction in which the power detected by the monitors 121 and 123 increases. That is, the AMZ 101 is controlled in a direction in which the optical power of light of λ1 and λ3 incident on the unit circuit UC2 at the next stage and the optical power of light of λ2 and λ4 incident on the unit circuit UC3 at the next stage are increased. In this sense, the controller 31 is represented by “Inc”.

The monitoring result of the monitor 122 is input to the controller 132. The controller 132 controls the phase shifter 112 of the AMZ 102 to control the transmission characteristic of the AMZ 102 in a direction in which the power detected by the monitor 122 decreases. That is, the AMZ 102 is controlled in a direction in which the components of the wavelengths λ2 and λ4, which are not necessary in the path on the AMZ 102 side, are decreased. In this sense, the controller 132 is represented by “Dec”. Similarly, the monitoring result of the monitor 123 is input to the controller 33. The controller 33 controls the phase shifter 113 of the AMZ 103 to control the transmission characteristic of the AMZ 103 in a direction in which the power detected by the monitor 123 decreases. That is, the AMZ 103 is controlled in a direction in which the components of the wavelengths λ1 and λ3, which are not necessary in the path on the AMZ103 side, are decreased. In this sense, the controller 33 is represented by “Dec”.

The arm length differences of the three AMZs included in each of the unit circuits UC2 and UC3 at the next stage are set to be ½ of the arm length differences of the AMZs of the unit circuit UC1 at the first stage. The wavelength separation interval is determined by the arm length difference, and the arm length difference that is half of the unit circuit UC1 at the first stage causes the wavelength separation interval to be doubled, and the wavelengths are separated at every other channel interval.

The unit circuit UC2 includes AMZs 201, 202, and 203 connected in a cascade, and phase shifters 211, 212, and 213 are provided in each of the AMZs 201, 202, and 203. The arm length difference of the AMZs 201, 202 and 203 are set so that λ1 is output to one output port and λ3 is output to the other output port. A monitor 221 is connected to one output port of the second AMZ 202, and the monitor 222 is connected to the other port. The output port to which the monitor 221 is connected is the output port of λ1. Similarly, a monitor 223 is connected to one output port of the third AMZ 203, and a monitor 224 is connected to the other output port. The output port to which the monitor 223 is connected is the output port of λ3.

The monitoring results of the monitors 221 and 223 are input to a control circuit 231. The control circuit 231 controls the phase shifter 211 of the AMZ 201 to control the transmission characteristic of the AMZ 201 in a direction in which the power detected by the monitors 221 and 223, that is, the power of the light of λ1 and λ3 output from the demultiplexer 131A increases. In this sense, the control circuit 231 is represented by “Inc”.

The monitoring result of the monitor 222 is input to the controller 232. The controller 232 controls the phase shifter 112 of the AMZ 202 to control the transmission characteristic of the AMZ 202 in a direction in which the power detected by the monitor 222, that is, the wavelength component of λ3 mixed in the λ1 output port decreases. In this sense, the controller 232 is represented by “Dec”. Similarly, the monitoring result of the monitor 223 is input to the controller 233. The controller 233 controls the phase shifter 213 of the AMZ 203 to control the transmission characteristic of the AMZ 203 in a direction in which the power detected by the monitor 223, that is, the wavelength component of λ1 mixed in the λ3 output port decreases. In this sense, the controller 233 is represented by “Dec”.

The unit circuit UC3 also performs an operation substantially the same as the unit circuit UC2 on λ2 and λ4, and outputs λ2 and λ4 from the demultiplexer 131A. In such a CAT configuration, because the respective AMZs constituting the demultiplexer 131A are controlled to increase the target wavelength component and decrease the unnecessary wavelength component, the demultiplex accuracy can be improved even when the designed demultiplexing cannot be performed due to the manufacturing variations, refractive index variations, and the like.

### <Configuration Example of Filter>

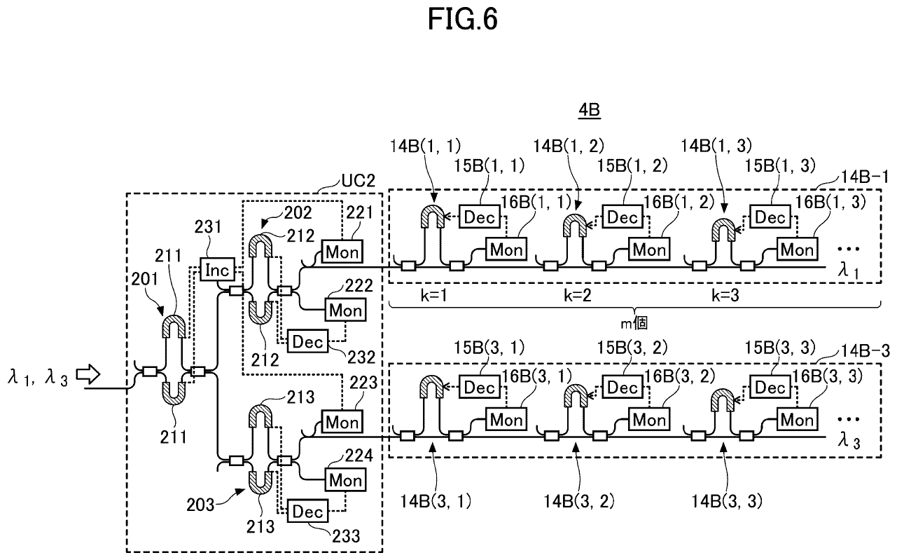

FIG. 6 is a schematic diagram illustrating filters connected to the output ports of the unit circuit UC2 of the demultiplexer 131A illustrated in FIG. 5. A filter section 4B includes a filter 14B-1 connected to one output port of the unit circuit UC2 and a filter 14B-3 connected to the other output port. Similarly, two filters are connected to the two outputs of the unit circuit UC3.

The filter 14B-1 includes m filters 14B(1, 1) to 14B(1, m) connected in series. Here, the first to third filters 14B(1, 1), 14B(1, 2), and 14B(1, 3) are illustrated. As described with reference to FIG. 4, a corresponding monitor 16B(1, k) is provided for each filter 14B(1, k), and the transmission spectrum of the filter 14B(1, k) is controlled by the controller 15B(1, k) based on the monitoring result.

In the example of FIG. 6, each filter 14B(i, k) is formed by the AMZ, and the arm length differences of m AMZs connected in series are different from each other. In the filter 14B-1, the arm length of the first filter 14B(1, 1) is set so that λ1 is transmitted to the first output port connected to the second filter 14B(1, 2) and a second order harmonic component of λ1 is output to the monitoring output port connected to the monitor 16B(1, 1). The controller 15B(1, 1) controls the transmission characteristic of the filter 14B(1, 1) so that the power detected by the monitor 16B(1, 1) is minimized. The transmission characteristic of the filter 14B(1, 1) is controlled by adjusting the temperature of the phase shifter such as a heater provided in the arm of the AMZ, for example.

The transmission characteristic of the second filter 14B(1, 2) is controlled so that λ1 is transmitted to the first output port connected to the third filter 14B(1, 3) and the third order harmonic component of λ1 is output to the monitoring output port connected to the monitor 16B(1, 2). The controller 15B (1, 2) controls the transmission characteristic of the filter 14B(1, 2) so that the optical power detected by the monitor 16B(1, 2) is minimized. By repeating these, the peak value of the transmission spectrum can be matched with the wavelength λ1 of the output port of this channel. In general, in each channel i, the peak of the transmission spectrum can be matched with the wavelength λi of the channel while reducing the high-order spectral component. This filter configuration can suppress crosstalk arising from a high-order spectrum.

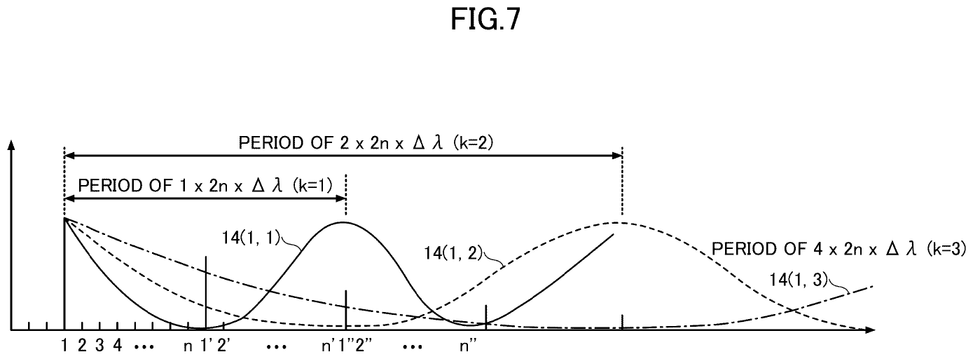

FIG. 7 illustrates the filter characteristic of the embodiment. The horizontal axis represents the frequency, and the vertical axis represents the power. Here, λ1 of the channel number 1 is focused. The solid line represents the transmission characteristic of the first filter 14(1, 1) of the filter 14-1 connected to the output port for λ1 of the demultiplexer section 13. When the channel interval is Δλ, the transmission spectrum of the filter 14(1, 1) (k=1) has a period of 1×2n×Δλ. By this period, the second order spectral component, which appears at the position of “1′″, is not transmitted and is removed.

The broken line represents the transmission characteristic of the second filter 14 (1, 2). The transmission spectrum of the filter 14 (1, 2) (k=2) has a period of 2×2n×Δλ. By this period, the third order spectral component, which appears at the position of “1″″ is not transmitted and is removed. The dash-dotted line represents the transmission characteristic of the third filter 14(1, 3). The transmission spectrum of the third filter 14(1, 3) has a period of 4×2n×Δλ. By this period, the high-order component is not transmitted and is removed. In general, the transmission spectrum of the k-th filter 14(1, k) has a period of 2^{k-1}×2n×Δλ, and effectively removes a high-order spectral component at a position corresponding to the trough of the cycle.

### <Wavelength Control>

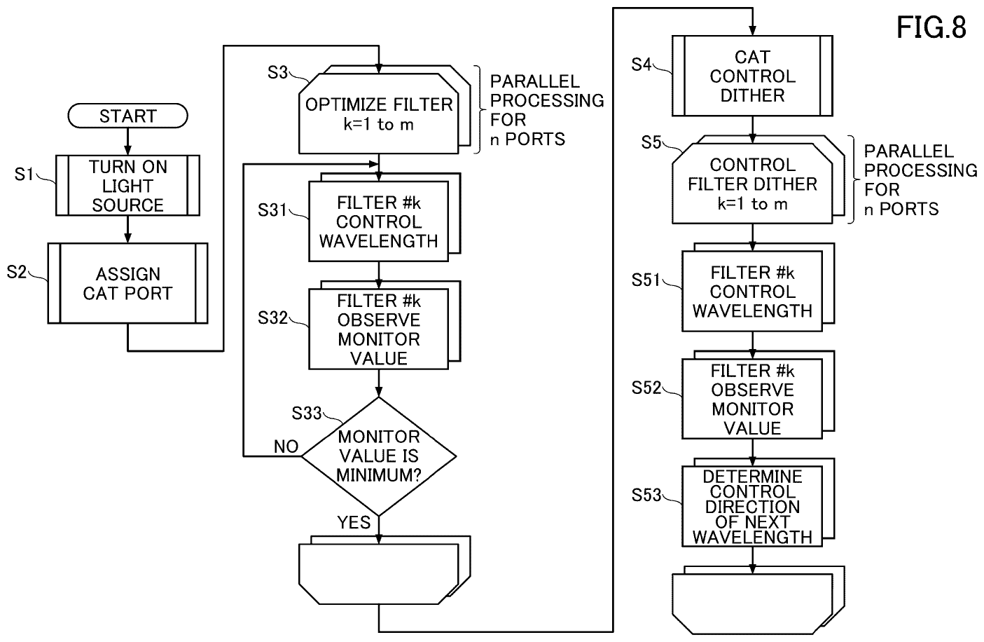

FIG. 8 is a flowchart of wavelength control of the optical transmitter 1Δλ. The optical transmitter 10A includes the filter section 4A including the array of the filters of FIG. 4 connected in series and the demultiplexer 131A having the CAT configuration of FIG. 5. First, the frequency comb light source 11 is turned on (S1), and wavelengths are assigned to the respective output ports of the demultiplexer 131A having the CAT configuration (S2). Light beams having the wavelengths λ1 to λn are incident on the demultiplexer 131A in order, and the transmission characteristic is adjusted by controlling the phase shifters provided on the waveguide between the input port of the demultiplexer 131A and the output port of the selected wavelength. That is, the phase shifters are controlled so that the monitor power is increased at a position where light of the target wavelength is output, and is decreased at positions of the other wavelength components to be monitored. When the output is stabilized at the selected wavelength, the phase shifters are controlled so that the monitor power becomes maximum at the output position of the target wavelength and becomes minimum at the positions of the other wavelength components to be monitored, for the next wavelength.

When the control of the phase shifters for the individual wavelengths is completed, signals of all the wavelengths λ1 to λn are incident on the demultiplexer 131A at once, and the phase shifters on the waveguides are controlled again. When the outputs of all the channels are stabilized in a state where the signals of all the wavelengths are incident, the port assignment of the demultiplexer 131A having the CAT configuration is completed.

Next, the filter section 4A is optimized (S3). The filter optimization is a process of adjusting, for each of the filters 14A-i (i is an integer from 1 to n) connected to the respective output ports of the demultiplexer 131A, the peaks of the transmission spectra of m filters 14A(i, k) connected in series to target wavelength Δi. The filter optimization may be performed in parallel for n ports. In each of the filters 14A-i, each of the m filters 14(i, k) is controlled (S31). The output power of the k-th filter (k is an integer from 1 to m) connected in series is monitored by the monitor 16(i, k) (S32). The controller 15(i, k) performs control so that the monitor value is minimized (S33). Steps S31 to S33 are repeated until the monitor values become minimum in the m filters.

At the time when the monitor values of all the m filters become minimum, the peaks of the transmission spectra of the filters 14A-i match with or are close to the wavelength Δi assigned to the corresponding port, and the high-order spectral components are reduced. As a result, the target wavelength Δi is extracted from the filter 14A-1.

After the filter optimization, a process of following the wavelength fluctuations of the frequency comb light source 11 may be performed. The wavelength of the frequency comb light source 11 fluctuates due to a temperature change or the like. In the frequency comb light source 11, even if the wavelength fluctuates, the repetition frequency fᵣ of each comb line is maintained constant, and thus, the entire power spectrum shifts in the same direction while maintaining the wavelength interval. By following the fluctuations in the wavelengths of the frequency comb light source 11, the demultiplexer 131A having the CAT configuration is dither-controlled (S4) and the filter section 4A is dither-controlled (S5).

A dither signal is incident on the demultiplexer 131A, and the change of the monitor light by the dither signal is observed to check whether the direction of the control following the fluctuations in the wavelengths of the frequency comb light source 11 is correct. Next, the filters 14A-1 to 14A-n connected to the respective output ports of the demultiplexer 131A are controlled by dither control to follow the fluctuations in the wavelengths (S5). The wavelength-fluctuation following process of the filter section 4A may be performed in parallel for the n ports.

A dither signal is input to the filter 14A-i of each port, and the m filters 14A(i, k) connected in series perform dither control (S51). A change in the dither component included in the monitor light is observed (S52), and the control direction of the filter 14A(i, k) is determined, for example, in a direction in which the dither component decreases (S53).

The wavelength-fluctuation following process (S4) of the demultiplexer 131A and the wavelength-fluctuation following process (S5) of the filter section 4A are repeatedly performed during the operation of the optical transmitter 1Δλ. With this, even if the wavelength fluctuation occurs in the frequency comb light source 11, the light of each wavelength can be separated with high accuracy following the wavelength fluctuations, and crosstalk of the high-order spectral component can be suppressed.

### <Modified Example of Filter>

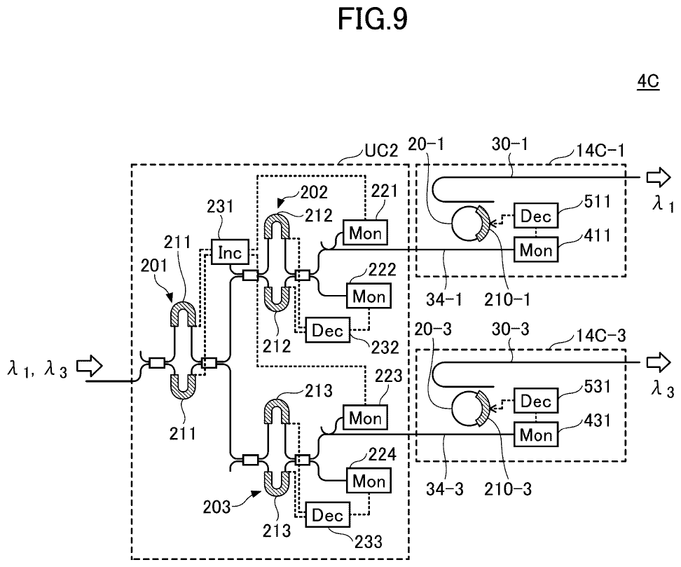

FIG. 9 is a schematic diagram illustrating a modified example of the filter. A filter section 4C uses a ring resonator instead of the AMZ. In FIG. 9, the demultiplexer 131A having the CAT configuration illustrated in FIG. 5 is assumed. The filters 14C-1 and 14C-3 are respectively connected to two output ports of the unit circuit at the final stage of the demultiplexer 131A (the unit circuit UC2 in the example of FIG. 5), and λ1 and λ3 are extracted. Similarly, the filters 14C-2 and 14C-4 are respectively connected to two output ports of another unit circuit at the final stage (for example, the unit circuit UC3), and λ2 and λ4 are extracted.

The output waveguide of the AMZ 202 of the unit circuit UC2 is an input waveguide 34-1 of the filter 14C-1. A portion of the light of λ1 guided in the input waveguide 34-1 is coupled to a ring resonator 20-1, circulates through the waveguide, and is coupled to the output waveguide 30-1. The ring resonator 20-1 is designed so that the product of the circumferential length thereof and the effective refractive index is an integer multiple of λ1. Among the light propagating through the input waveguide 34-1, light corresponding to the resonance wavelength of the ring resonator 20-1 is coupled to the ring resonator 20-1, and the other light propagates straight through the input waveguide 34-1 and is monitored by a monitor 411. The monitoring result of the monitor 411 is supplied to a controller 511. The controller 511 controls a phase shifter 210-1 provided in the ring resonator 20-1 so that the power detected by the monitor 411 decreases. In this sense, the controller 511 is represented by “Dec”. Thus, λ1 can be output with the maximum power.

The ring resonator 20-1 has a periodic resonance peak. In the embodiment, the free spectral range (FSR) of the ring resonator 20-1, that is, the resonance peak interval is set to be greater than n times the channel interval Δλ(FSR>nΔλ). Here, n is the number of channels. By designing the resonance characteristic of the ring resonator 20-1 in such a way, the high-order spectral component can be effectively removed.

The filter 14C-3 has a configuration substantially the same as the filter 14C-1, but the circumferential length of the ring resonator 20-3 is different. The circumferential length of the ring resonator 20-3 is designed so that the product of the circumferential length and the effective refractive index is an integer multiple of λ3. An operation of a monitor 431 and a controller 531 is the same as an operation of the monitor 411 and the controller 511. The ring resonator 20-3 is also designed so that its FSR satisfies FSR>nΔλ.

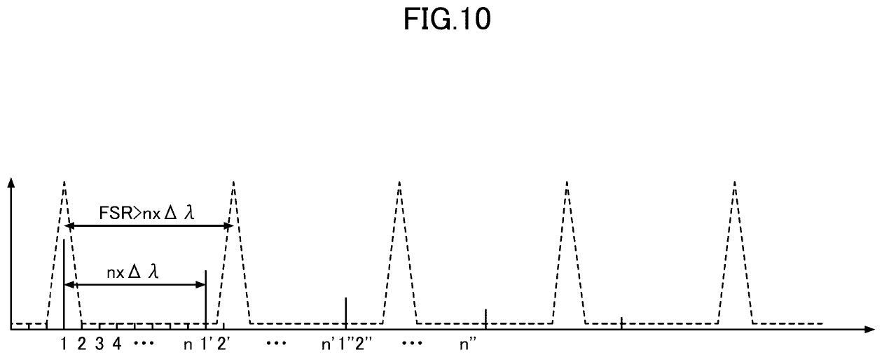

FIG. 10 illustrates the transmission characteristic of the filter 14C-1 of FIG. 9. The dotted line indicates the transmission spectrum of the ring resonator 20-1. The wavelength λ1 is focused. The transmission band for n channels is n×Δλ. It is desirable to remove the higher-order spectra that appear outside this band. Therefore, the transmission characteristic is designed so that the transmission peak of the ring resonator 20-1 appears at a position where the high-order spectral component does not transmit. This allows the higher-order spectral component to be effectively removed in the channel at λ1.

In the WDM transmission of n channels having a channel interval LA, the peak position of the transmission spectrum of the ring resonator 20-i is matched with Δi, and the FSR of the ring resonator 20-i is set to FSR>nΔλ, so that the wavelength fluctuations of the frequency comb light source 11 can be followed, and the high-order spectral component can be effectively removed.

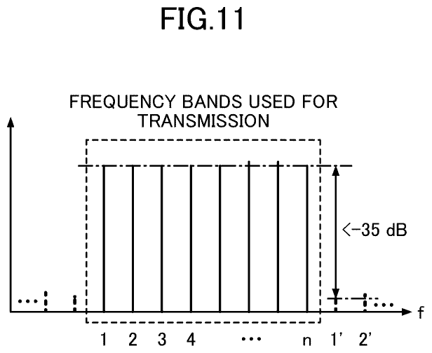

FIG. 11 illustrates the effect of the configuration of the embodiment. In the WDM transmission of n channels, the power spectra generated on both sides of the wavelength band used in the transmission can be greatly reduced, and the difference between the target wavelength and the higher-order spectral components of the target wavelength can be made smaller than −35 dB. With this, the crosstalk requirement can be satisfied and the signal quality can be improved.

When the CAT configuration is adopted for the demultiplexer 131, the filter characteristic can be made to follow the wavelength fluctuations of the frequency comb light source 11, as in the CAT. The multiplexer having the CAT configuration and the periodic filter section 4 can be integrated on the same substrate by the silicon photonics technology, and the miniaturization of the optical transmitter 10 is realized.

In the optical transmitter 10, the light output from the frequency comb light source 11 is demultiplexed into n channels (n is an integer of 2 or greater) at a wavelength interval Δλ by the demultiplexer 131, the filters 14-1 to 14-n are respectively provided to n output ports of the demultiplexer 131 to reduce the high-order spectral component of each channel, and each filter 14-i is controlled to bring the peak of the transmission spectrum of the filter 14-i close to the wavelength appearing at the corresponding output port of the demultiplexer 131. By this control, the transmission spectrum of the filter can be made to follow the fluctuations of the frequency comb light source 11, and crosstalk caused by the high-order component can be suppressed.

### <Application to Optical Transceiver>

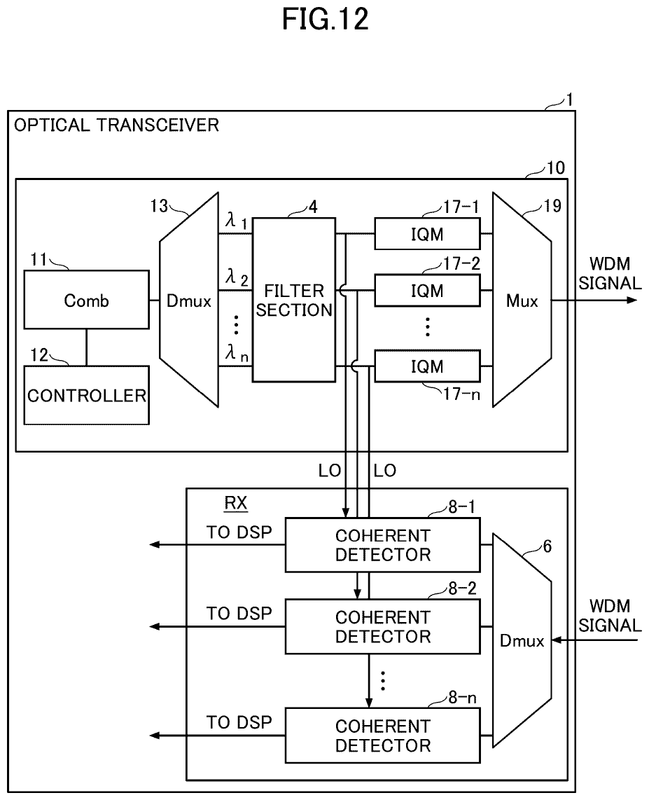

FIG. 12 is a schematic diagram of an optical transceiver 1 using the optical transmitter 10 of the embodiment. The optical transceiver 1 includes the optical transmitter 10 and a receiver RX. The optical transmitter 10 has the configuration described with reference to FIG. 3 to FIG. 11, and includes the frequency comb light source 11, the controller 12, the demultiplexer section 13, the filter section 4, the modulators 17-1 to 17-n, and the multiplexer 19. By providing the filter section 4, the high-order spectral component of the light of each wavelength transmitted due to the periodicity of the transmission characteristic of the demultiplexer section 13 is removed.

The receiver RX includes a demultiplexer 6 and coherent detectors 8-1 to 8-n connected to the respective outputs of the demultiplexer 6. A portion of the output light of each channel of the filter section 4 of the optical transmitter 10 may be branched and used as local oscillation light LO. The local oscillation light LO is supplied to the coherent detectors 8-1 to 8-n of the receiver RX and used for detection of the reception signals of the respective channels. The signals detected by the respective coherent detectors 8-1 to 8-n and converted into electric signals are input to a digital signal processor (DSP) and signal processing is performed. The DSP may be implemented on the optical transceiver 1 or may be provided outside the optical transceiver 1.

By using the frequency comb light source 11, the optical transceiver 1 can be miniaturized, and power consumption can be reduced to support optical transmission of the DWDM system. By providing the filter section 4 at the output port of the demultiplexer section 13, the high-order spectral component in each channel can be reduced to suppress crosstalk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmitter comprising:
a frequency comb light source;
a demultiplexer configured to demultiplex light output from the frequency comb light source into n channels (n is an integer of 2 or greater) at a wavelength interval Δλ; and
n filters respectively connected to n output ports of the demultiplexer, the n filters being configured to reduce a high-order spectral component for each wavelength.

2. The optical transmitter as claimed in claim 1, further comprising a controller configured to control a peak wavelength of a transmission spectrum of each of the n filters.

3. The optical transmitter as claimed in claim 2, wherein each of the n filters includes one or more asymmetric Mach-Zehnder interferometers connected in series.

4. The optical transmitter as claimed in claim 3, wherein a k-th asymmetric Mach-Zehnder interferometer (k is an integer of 1 or greater) among the one or more asymmetric Mach-Zehnder interferometers has a transmission characteristic having a period of 2^{k-1}×2n×Δλ.

5. The optical transmitter as claimed in claim 2, wherein each of the n filters includes a resonator configured to resonate with a corresponding channel wavelength.

6. The optical transmitter as claimed in claim 5, wherein a free spectral range of the resonator is greater than n×Δλ.

7. The optical transmitter as claimed in claim 1,
wherein the demultiplexer includes 2^{L}−1 unit circuits connected in a tree-shaped branching structure in L stages (L is an integer of 1 or greater),
wherein each of the 2^{L}−1 unit circuits has one input port and two outputs ports, and
wherein the n filters are respectively connected to output ports of a unit circuit at an L-th stage among the L stages.

8. The optical transmitter as claimed in claim 7,
wherein each of the 2^{L}−1 unit circuits includes a first asymmetric Mach-Zehnder interferometer, a second asymmetric Mach-Zehnder interferometer, and a third asymmetric Mach-Zehnder interferometer having an identical arm length difference, and
wherein an arm length difference of a unit circuit at the L-th stage is ½ of an arm length difference of a unit circuit at an (L−1)-th stage among the L stages.

9. The optical transmitter as claimed in claim 1, further comprising:
n optical modulators provided corresponding to the n filters; and
a multiplexer configured to multiplex output light of the n optical modulators.

10. An optical transceiver comprising:
the optical transmitter as claimed in claim 1; and
an optical receiver;
wherein the optical receiver demultiplexes received a wavelength division multiplexing signal into optical signals of respective wavelengths, and detects the demultiplexed optical signals of the respective wavelengths by using a portion of light transmitted through the n filters of the optical transmitter as local oscillation light.

11. A wavelength control method comprising:
demultiplexing, by a demultiplexer, light output from a frequency comb light source into n channels (n is an integer of 2 or greater) at a wavelength interval Δλ; and
controlling a filter to bring a peak of a transmission spectrum of the filter close to a wavelength appearing at a corresponding output port of the demultiplexer to reduce a high-order spectral component for each wavelength, the filter being provided to each of n output ports of the demultiplexer.
